(19) United States
(12) Patent Application Publication
(10) Pub. No.: US 2023/0382299 A1
(43) Pub. Date: Nov. 30, 2023

(54) DRIVING SUPPORT DEVICE, DRIVING SUPPORT UNIT, STORAGE MEDIUM, AND DRIVING SUPPORT METHOD

(71) Applicant: HONDA MOTOR CO., LTD., Tokyo (JP)

(72) Inventors: Jovin Jeevan Dsa, Wako-shi (JP); Akira Kanehara, Wako-shi (JP)

(21) Appl. No.: 18/202,331

(22) Filed: May 26, 2023

(30) Foreign Application Priority Data
May 31, 2022 (JP) 2022-089203

(51) Int. Cl. B60Q 9/00; G06V 20/56; G06V 20/59; G06T 7/70; G06V 20/58; G06V 10/12

(52) U.S. Cl. CPC B60Q 9/00; G06V 20/588; G06V 20/597; G06T 7/70; G06V 20/58; G06V 10/12; G06T 2207/30201; G06T 2207/30256; G06T 2207/30268; G06V 2201/08

(57) ABSTRACT

A driving support device is detachably attached to a vehicle via a detachable member and performs: acquiring one or more images obtained by imaging a surrounding situation of the vehicle; and determining a notification intensity of a notification for a driver of the vehicle on the basis of a change of a target in the one or more images when it is predicted on the basis of information acquired from the one or more images that the vehicle is to depart from a traveling lane in which the vehicle is traveling and causing a notifier to output a notification of the determined notification intensity.

### CROSS-REFERENCE TO RELATED APPLICATION

Priority is claimed on Japanese Patent Application No. 2022-089203, filed May 31, 2022, the content of which is incorporated herein by reference.

### BACKGROUND

### Field

The present invention relates to a driving support device, a driving support unit, a storage medium, and a driving support method.

### Description of Related Art

In the related art, an alarm device that does not output an alarm from an alarm outputter when zigzag traveling of a vehicle is detected and when control for preventing departure of the vehicle from a lane is being performed and a driver is not touching a steering operator that receives a steering operation of the vehicle is disclosed (PCT International Publication No. WO2021/153606 and Japanese Unexamined Patent Application, First Publication No. 2021-066197).

### SUMMARY

However, in the aforementioned related art, an alarm may not be able to be simply and accurately output.

The present invention was made in consideration of the aforementioned circumstances, and an objective thereof is to provide a driving support device, a driving support unit, a storage medium, and a driving support method that can simply and accurately output an alarm.

A driving support device, a driving support unit, a storage medium, and a driving support method according to the present invention employ the following configurations.

(1) According to an aspect of the present invention, a driving support device is provided that is detachably attached to a vehicle via a detachable member, the driving support device including: a storage medium storing computer-readable instructions; and one or more processors connected to the storage medium, wherein the one or more processors execute the computer-readable instructions to perform: acquiring one or more images obtained by imaging a surrounding situation of the vehicle; and determining a notification intensity of a notification for a driver of the vehicle on the basis of a change of a target in the one or more images when it is predicted on the basis of information acquired from the one or more images that the vehicle is to depart from a traveling lane in which the vehicle is traveling and causing a notifier to output a notification of the determined notification intensity.

(2) In the aspect of (1), the target may be a road marking of a lane in which the vehicle is traveling and a driver of the vehicle, and the change of the target may be a change of a position of the vehicle relative to the road marking and a change in behavior of the driver.

(3) In the aspect of (1) or (2), the one or more images may include an image in which a face of the driver driving the vehicle appears, and the one or more processors execute the computer-readable instructions to perform causing the notifier to output a notification of a higher notification intensity when a direction of the driver's face or sightline based on the one or more images is outside of a preset range than when the direction of the driver's face or sightline is not outside of the preset range.

(4) In one of the aspects of (1) to (3), the one or more images may include an image in which a face of the driver driving the vehicle appears, and the one or more processors execute the computer-readable instructions to perform: causing the notifier to output a notification of an alarm with a predetermined intensity when it is determined (a1) that a direction of the driver's face or sightline based on the one or more images is fixed to a traveling direction and is not a leftward direction of the vehicle for a predetermined time or more and (a2) that the vehicle is swinging in the leftward direction on the basis of the one or more images and causing the notifier to output a notification of an alarm with a lower intensity than the predetermined intensity or causing the notifier not to output a notification of an alarm when one or both of (a1) and (a2) are not satisfied; and causing the notifier to output a notification of an alarm with a predetermined intensity when it is determined (b1) that the direction of the driver's face or sightline based on the one or more images is fixed to the traveling direction and is not a rightward direction of the vehicle for a predetermined time or more and (b2) that the vehicle is swinging in the rightward direction on the basis of the one or more images and causing the notifier to output a notification of an alarm with a lower intensity than the predetermined intensity or causing the notifier not to output a notification of an alarm when one or both of (b1) and (b2) are not satisfied.

(5) In the aspect of (4), the one or more images may include an image in which a rear nearby area behind the vehicle in a neighboring lane adjacent to the traveling lane appears, and the one or more processors may execute the computer-readable instructions to perform: causing the notifier to output a notification of a third alarm with a higher intensity than the predetermined intensity when (a1) and (a2) are satisfied and it is determined (a3) that there is a vehicle in the rear nearby area on the left of the vehicle on the basis of the one or more images; causing the notifier to output a notification of a second alarm with an intensity higher than the predetermined intensity and lower than that of the third alarm when (a1) and (a2) are satisfied and (a3) is not satisfied; causing the notifier to output a notification of the third alarm with a higher intensity than the predetermined intensity when (b1) and (b2) are satisfied and it is determined (b3) that there is a vehicle in the rear nearby area on the right of the vehicle on the basis of the one or more images; and causing the notifier to output a notification of the second alarm when (b1) and (b2) are satisfied and (b3) is not satisfied.

(6) In one of the aspects of (1) to (5), the one or more images may include an image in which one or both of an arm or a hand of the driver appear, and the one or more processors execute the computer-readable instructions to perform: causing the notifier to output a notification of an alarm with a predetermined intensity when it is determined (c1) that the hand or the arm does not perform an operation of controlling steering of moving the vehicle to the left on the basis of the one or more images and (c2) that the vehicle is swinging in the leftward direction on the basis of the one or more images and causing the notifier to output a notification of an alarm with a lower intensity than the predetermined intensity or causing the notifier not to output a notification of an alarm when one or both of (c1) and (c2) are not satisfied, and causing the notifier to output a notification of an alarm with a predetermined intensity when it is determined (d1) that the hand or the arm does not perform an operation of controlling steering of moving the vehicle to the right on the basis of the one or more images and (d2) that the vehicle is swinging in the rightward direction on the basis of the one or more images and causing the notifier to output a notification of an alarm with a lower intensity than the predetermined intensity or causing the notifier not to output a notification of an alarm when one or both of (d1) and (d2) are not satisfied.

(7) In the aspect of (6), the one or more images may include an image in which a rear nearby area behind the vehicle in a neighboring lane adjacent to the traveling lane appears, and the one or more processors may execute the computer-readable instructions to perform: causing the notifier to output a notification of a third alarm with a higher intensity than the predetermined intensity when (c1) and (c2) are satisfied and it is determined (c3) that there is a vehicle in the rear nearby area on the left of the vehicle on the basis of the one or more images; causing the notifier to output a notification of a second alarm with an intensity higher than the predetermined intensity and lower than that of the third alarm when (c1) and (c2) are satisfied and (c3) is not satisfied; causing the notifier to output a notification of the third alarm with a higher intensity than the predetermined intensity when (d1) and (d2) are satisfied and it is determined (d3) that there is a vehicle in the rear nearby area on the right of the vehicle on the basis of the one or more images; and causing the notifier to output a notification of the second alarm when (d1) and (d2) are satisfied and (d3) is not satisfied.

(8) In one of the aspects of (1) to (7), the one or more images may include an image in which a rear nearby area behind the vehicle in a neighboring lane adjacent to the traveling lane appears, and the one or more processors may execute the computer-readable instructions to perform causing the notifier to output a notification of a third alarm with a higher intensity than the predetermined intensity when it is determined on the basis of the one or more images that there is a vehicle in the rear nearby area than that of when it is determined that there no vehicle in the rear nearby area.

(9) According to another aspect of the present invention, there is provided a driving support unit including: the driving support device according to any one of the aspects of (1) to (8) including a communicator configured to transmit information for causing the notifier to output the notification to the notifier; a first camera not connected to an onboard network of the vehicle and configured to acquire an image which is included in the one or more images and includes a surrounding situation on the front of the vehicle; a second camera not connected to the onboard network of the vehicle and configured to capture an image which is included in the one or more images and which includes the driver, a window of a driver's seat side of the vehicle, a window on a passenger's seat of the vehicle, and a rear area of the vehicle; and a housing accommodating the driving support device, the first camera, and the second camera.

(10) According to another aspect of the present invention, there is provided a storage medium storing an application program that is installed in a mobile terminal device not connected to an onboard network of a vehicle, the application program causing a computer of the mobile terminal device to perform: a process of acquiring one or more images captured by imaging a surrounding situation of the vehicle; and a process of determining a notification intensity of a notification for a driver of the vehicle on the basis of a change of a target in the one or more images when it is predicted that the vehicle is to depart from a traveling lane in which the vehicle is traveling on the basis of information acquired from the one or more images.

(11) According to another aspect of the present invention, a driving support method there is provided that is performed by a computer of a driving support device that is detachably attached to a vehicle via a detachable member, the driving support method including: acquiring one or more images obtained by imaging a surrounding situation of the vehicle; and determining a notification intensity of a notification for a driver of the vehicle on the basis of a change of a target in the one or more images when it is predicted on the basis of information acquired from the one or more images that the vehicle is to depart from a traveling lane in which the vehicle is traveling and causing a notifier to output a notification of the determined notification intensity.

(12) According to another aspect of the present invention, a control program provided for causing a computer of a driving support device that is detachably attached to a vehicle via a detachable member to perform: a process of acquiring one or more images obtained by imaging a surrounding situation of the vehicle; and a process of determining a notification intensity of a notification for a driver of the vehicle on the basis of a change of a target in the one or more images when it is predicted on the basis of information acquired from the one or more images that the vehicle is to depart from a traveling lane in which the vehicle is traveling and causing a notifier to output a notification of the determined notification intensity.

According to the aspects of (1) to (11), it is possible to simply and accurately output an alarm. For example, the driving support device has a simple configuration that is post-installed in a vehicle. The driving support device can accurately determine swinging or departure of a vehicle or the like using an image.

According to the aspects of (2), (3), and (5), since a driver's intention is considered, it is possible to more accurately output an alarm for notifying swinging.

According to the aspects of (4), (6), and (7), since nearby vehicles are considered, it is possible to output a more appropriate alarm and to realize control in consideration of the surroundings.

### BRIEF DESCRIPTION OF THE DRAWINGS

FIG. 1 is a diagram showing an example of a configuration and a use environment of a driving monitoring device including a driving support device according to an embodiment.

FIG. 2 is a diagram showing an example of the driving monitoring device.

FIG. 3 is a diagram showing an example of an image that is acquired by the driving monitoring device.

FIG. 4 is a diagram schematically showing an alarm process that is performed by a controller.

FIG. 5 is a diagram showing an example of functional units of a departure determiner.

FIG. 6 is a diagram showing processing of an offset processor.

FIG. 7 is a diagram showing a noise area.

FIG. 8 is a diagram showing processing of an integrated processor.

FIG. 9 is a flowchart showing an example of a flow of processes that are performed by an intention determiner.

FIG. 10 is a diagram showing an example of a checklist.

FIG. 11 is a flowchart showing an example of the flow of processes that are performed by the intention determiner.

FIG. 12 is a flowchart showing another example of the flow of processes that are performed by the intention determiner.

FIG. 13 is a diagram showing an intention flag “TRUE.”

FIG. 14 is one routine of a flowchart showing an example of a flow of processes that are performed by an alarm controller.

### DETAILED DESCRIPTION

Hereinafter, a driving support device, a driving support unit, a storage medium, and a driving support method according to an embodiment of the present invention will be described with reference to the accompanying drawings. In the following description, a forward direction of a vehicle is defined as a plus X direction, a rearward direction of the vehicle is defined as a minus X direction, a rightward direction which is a width direction of the vehicle with respect to the plus X direction is defined as a plus Y direction, a leftward direction of the vehicle is defined as a minus Y direction, and a height direction of the vehicle perpendicular to the X direction and the Y direction is defined as a plus Z direction.

Entire Configuration

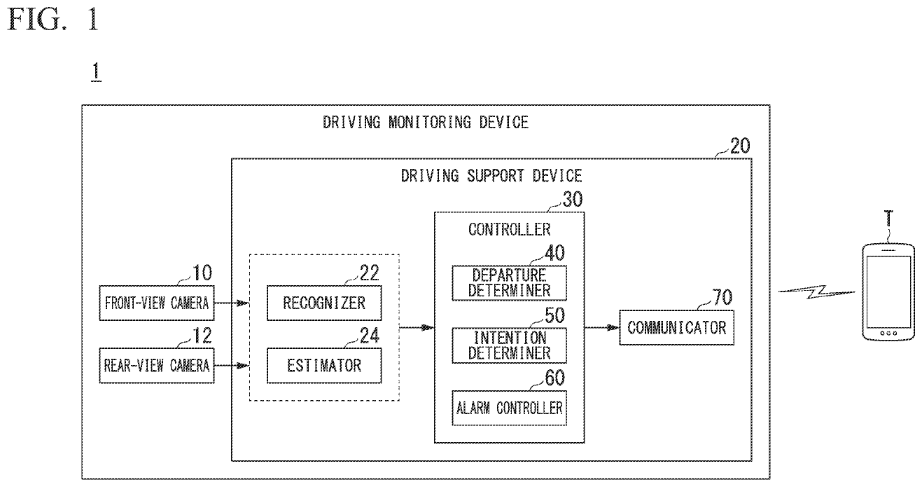

FIG. 1 is a diagram showing an example of a configuration and a use environment of a driving monitoring device 1 (a driving support system) including a driving support device according to an embodiment. A driving support device 20 is mounted in the driving monitoring device 1 that is post-installed in a vehicle (hereinafter referred to as a “vehicle M”) such as a drive recorder. That is, the driving monitoring device 1 (the driving support device 20) is detachably attached to the vehicle M via a detachable member. The driving support device 20 is, for example, a device that is not connected to an onboard network of the vehicle M. The onboard network is an onboard network using a communication standard such as a controller area network (CAN) to which an electronic controller associated with driving, braking, and steering of the vehicle M or control of a vehicle such as various sensors, a driving operator, and an operation button of the vehicle is connected. The network of the vehicle M for a human-machine interface (HMI) may be excluded from the onboard network.

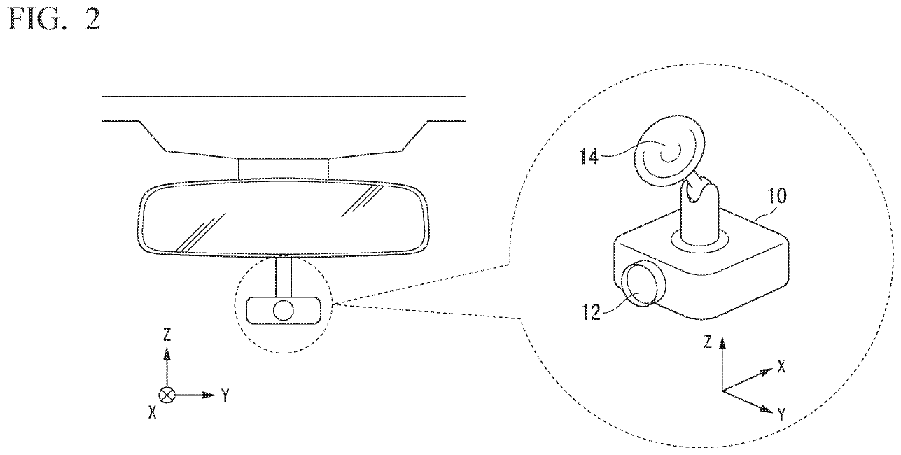

FIG. 2 is a diagram showing an example of the driving monitoring device 1. The driving monitoring device 1 is attached to, for example, a front windshield in the vicinity of a rear-view mirror in an upper part of a front windshield. The driving monitoring device 1 stores images (moving images) captured by a front-view camera 10 and a rear-view camera 12, for example, in a storage device which is not shown. The driving monitoring device 1 may have a configuration in which a display device such as a liquid crystal display (LCD) is provided and the images (moving images) stored in the storage device can be displayed on the display device.

The driving monitoring device 1 includes, for example, the front-view camera 10, the rear-view camera 12, a detachable member 14, and the driving support device 20. Each of the front-view camera 10 and the rear-view camera 12 is a digital camera using a solid-state imaging device such as a charge coupled device (CCD) or a complementary metal oxide semiconductor (CMOS). The front-view camera 10 images the surroundings in front of the vehicle M from a position to which the driving monitoring device 1 is installed repeatedly (periodically). The rear-view camera 12 images the surroundings behind the vehicle M from a position to which the driving monitoring device 1 is installed repeatedly (periodically). A viewing angle in a horizontal direction of each of the front-view camera 10 and the rear-view camera 12 is, for example, 180°. That is, the driving monitoring device 1 captures an image in the range of 360° around the vehicle M from the installation position. In this embodiment, the front-view camera and the rear-view camera 12 are used, but another camera may be used instead thereof or in addition thereto. That is, a camera has only to be constructed such that images (an image in which road markings appear and an image in which a driver's face appear) used in this embodiment are captured. The detachable member 14 is, for example, a member for attaching the driving monitoring device 1 to the vehicle M. The detachable member 14 is, for example, an arbitrary member which is a support member such as a sucker, a seal, or a bracket.

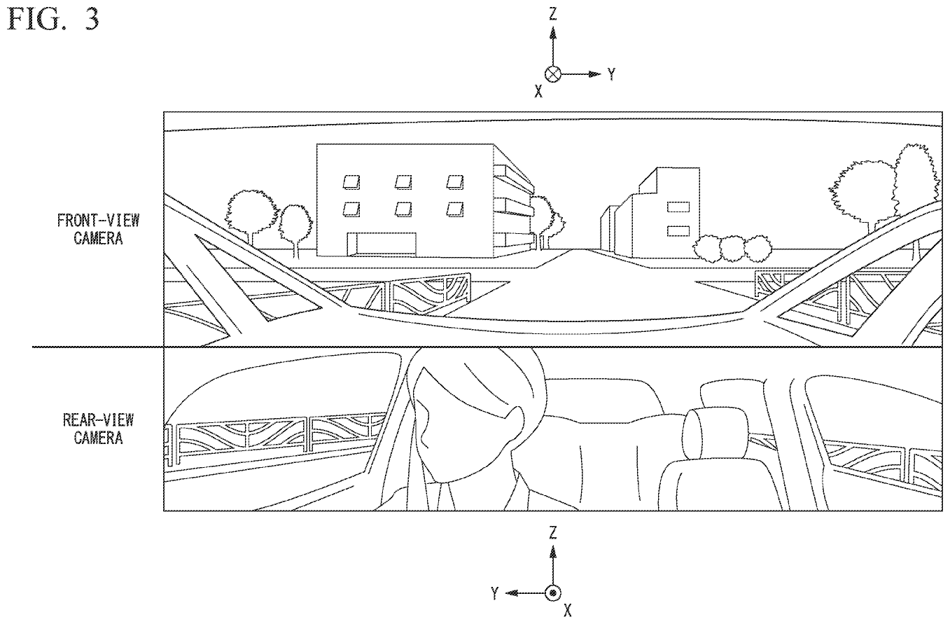

FIG. 3 is a diagram showing an example of an image that is acquired by the driving monitoring device 1. The front-view camera 10 images the front view of the vehicle M over a front windshield. The rear-view camera 12 images a driver of the vehicle M, a window of a driver's seat, a window of a passenger's seat, the rear view of the vehicle M, and the like.

In an image captured by the front-view camera 10 (hereinafter referred to as a “front-view image”), for example, objects in front of the vehicle M seen through a front windshield or on the right and left sides (in front) of the vehicle M seen through right and left side windshields such as another vehicle, a pedestrian, a bicycle, a fixed object, and road markings appear as subjects. The driving support device 20 recognizes the objects through an image recognition process.

In an image captured by the rear-view camera 12 (hereinafter referred to as a “rear-view image”), a cabin of the vehicle M and objects behind the vehicle M seen through a rear windshield or on the right and left sides of (behind) the vehicle M seen through right and left side windshields appear. Accordingly, at least a driver of the vehicle M to which the driving monitoring device 1 is attached appears as a subject in the rear-view image captured by the rear-view camera 12. The driving monitoring device 1 may be attached to an arbitrary position at which the front-view camera 10 and the rear-view camera 12 can image the aforementioned areas.

The driving support device 20 causes a terminal device T to output an alarm on the basis of results of reference to the front-view image output from the front-view camera 10 and the rear-view image output from the rear-view camera 12.

The terminal device T is, for example, a portable terminal device that is used by a driver driving the vehicle M to which the driving monitoring device 1 is attached such as a smartphone or a tablet terminal. In the terminal device T, for example, an application for providing driving support using the driving support device 20 is executed. The application causes a display device to display an image based on information or a notification transmitted by the driving support device 20 or causes a speaker to output sound based thereon. The terminal device T is an example of a “notifier.” For example, the terminal device T is detachably attached to the vehicle M and is used. For example, a holder for the terminal device T including a detachable member for one or both of the terminal device T and the vehicle M is provided, and the terminal device T is held by the holder. Instead of the terminal device T, a navigation of the vehicle M or a display or a speaker of the vehicle M may output an alarm on the basis of an instruction from the driving support device 20. A display (a notifier), a speaker (a notifier), or the like may be provided in the driving monitoring device 1 instead of the terminal device T.

As shown in FIG. 1, the driving support device 20 includes, for example, a recognizer 22, an estimator 24, a controller 30, and a communicator 70. For example, a hardware processor such as a central processing unit (CPU) and a storage device (a storage device including a non-transitory storage medium) storing a program (software) are provided in the recognizer 22, the estimator 24, and the controller 30 (a notification controller), and functions thereof are realized by causing the processor to execute the program. Some or all of such constituents may be realized by hardware (a circuit unit which includes circuitry) such as a large scale integration (LSI), an application-specific integrated circuit (ASIC), or a field-programmable gate array (FPGA), or a graphics processing unit (GPU) or functions of the constituents may be cooperatively realized by software and hardware. The functions of some or all of such constituents may be realized by a dedicated LSI.

The program (software) may be stored in a storage device (not shown) of the driving support device 20 such as a read only memory (ROM), a random access memory (RAM), or a flash memory (a storage device including a non-transitory storage medium) in advance, or may be stored in a removable storage medium such as a memory card (a removable storage medium) and installed in the storage device by setting the removable storage medium to the driving monitoring device 1. The program (software) may be downloaded in advance from another computer device through short-range communication or wide area communication by the application executed in the terminal device T and transmitted from the terminal device T, whereby the program may be installed in the storage device.

The recognizer 22 recognizes a traveling lane in which the vehicle M is traveling, an object (such as another vehicle or road markings), and the like on the basis of the front-view image. The other vehicle includes a vehicle traveling in the same traveling lane or a neighboring lane, a vehicle traveling in a neighboring lane behind the vehicle M, and an oncoming vehicle traveling in an oncoming lane. Recognition of an object in the recognizer 22 may be performed, for example, by a process such as deep learning. The recognizer 22 recognizes a state (such as a speed in a traveling direction, a speed in a lateral direction, or a yaw rate) of the vehicle M (the driving support device or a position of the vehicle M on the basis of a change in the front-view image or the rear-view image (for example, an area occupied by an object of interest in the image). The recognizer 22 may identify or compensate for the position or the state of the vehicle M using an inertial navigation system (INS) using outputs of vehicle sensors (not shown) of the vehicle M when the recognizer can communicate with the vehicle M.

The estimator 24 estimates a direction of a face or a direction of a sightline of a driver appearing in the rear-view image. In the following description, information indicating the estimated sightline direction of the driver may also be referred to as “sightline information.”

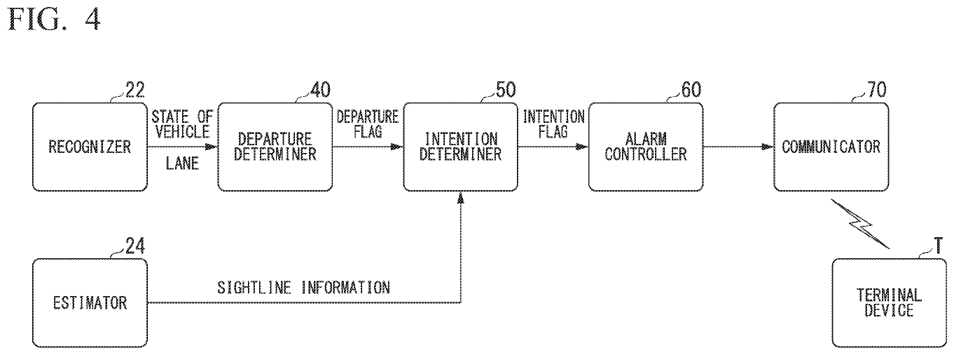

The controller 30 includes a departure determiner 40, an intention determiner 50, and an alarm controller 60. FIG. 4 is a diagram schematically showing an alarm process that is performed by the controller 30. The departure determiner 40 determines whether the vehicle M is likely to depart from the traveling lane on the basis of the state of the vehicle M and the position of the lane markings of the traveling lane in which the vehicle M is traveling.

The intention determiner 50 determines whether the vehicle M is likely to depart from the traveling lane according to the driver's intention on the basis of the sightline information acquired from the estimator 24. The alarm controller 60 causes the terminal device T to output an alarm on the basis of the result of determination (for example, a departure flag) from the departure determiner 40 and the result of determination (for example, an intention flag) from the intention determiner 50. For example, the alarm controller 60 transmits alarm information to the terminal device T via the communicator 70. The terminal device T outputs an alarm on the basis of information indicating a type of an alarm such as an intensity of the alarm included in the alarm information. The communicator 70 is a communication interface for wireless communication or wired communication with the terminal device T.

The processes of the departure determiner 40, the intention determiner 50, and the alarm controller 60 will be described below.

Process Details of Departure Determiner

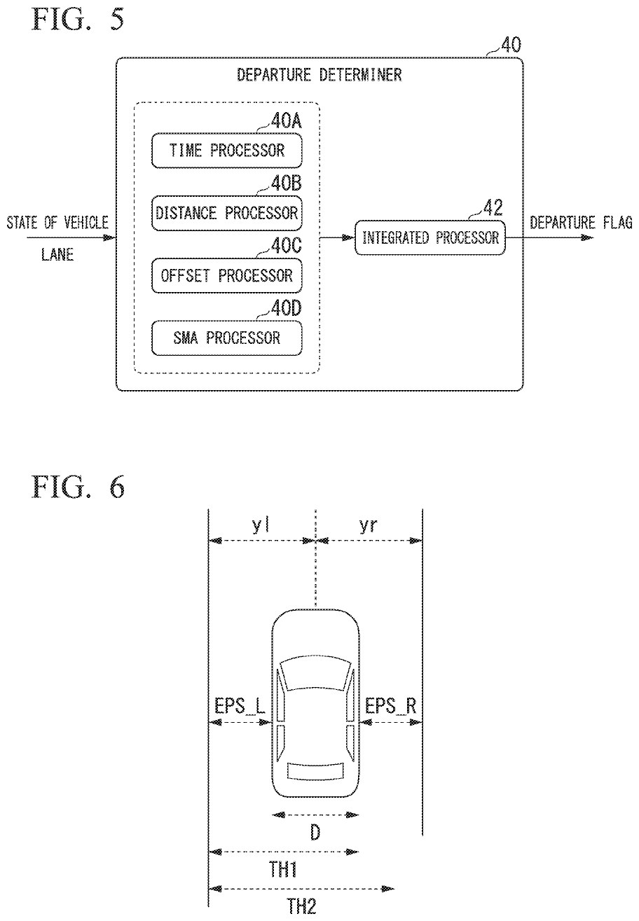

FIG. 5 is a diagram showing an example of functional units of the departure determiner 40. The departure determiner 40 includes, for example, a time processor a distance processor 40B, an offset processor 40C, a simple moving average (SMA) processor 40D, and an integrated processor 42. The departure determiner 40 acquires information indicating positions of lane markings or the state of the vehicle M from the recognizer 22. The departure determiner 40 repeatedly performs various processes which will be described below at intervals of a predetermined period.

When all or some of the following conditions are not satisfied, the departure determiner 40 may not perform various processes described below and may not determine departure. Examples of the conditions include a condition that a driver has performed an operation for intending to stop processing, a condition that lane markings could not be detected, and a condition that accuracy of detection of lane markings is equal to or less than a threshold value. Examples of the conditions may include a condition that a curvature of the traveling lane in which the vehicle M is traveling is equal to or greater than a threshold value (indicates a steep curve). Information of the curvature of the traveling lane is, for example, information provided by the terminal device T or a navigation device of the vehicle M. When the conditions for performing processing are not satisfied in this way, the departure determiner 40 reduces a processing load and curbs outputting of an alarm to the terminal device T.

Time Processor

The time processor 40A derives a time TLC until the vehicle M will go over a lane marking. The time TLC is, for example, a value obtained by dividing a distance from a reference position of the vehicle M to the lane marking by a speed in the lateral direction of the vehicle M. The time processor 40A outputs a red-label flag (for example, a first index) when the time TLC until the vehicle M will go over the lane marking is equal to or greater than a threshold value and outputs a green-label flag (for example, a second index) when the time TLC is less than the threshold value.

The time processor 40A may calculate the time TLC, for example, on the basis of Expression (1) and Expression (2). “ϕ” denotes a yaw direction and is a direction of the vehicle M with respect to an extending direction of the traveling lane. “Vy” denotes a speed in the lateral direction of the vehicle M, and “V” denotes a speed in which the speed in the longitudinal direction of a vehicle and the speed in the lateral direction are combined. “y₁” denotes a distance to the left lane, and “yᵣ” is a distance to the right lane. “D” denotes a length in the width direction of the vehicle. “l_{f}” denotes a distance from the center of gravity of the vehicle M (a position at which the driving support device 20 is installed) to an axle of the front wheels. “l_{f}” may be set to “zero.”

When “ϕ>0” is satisfied, it means that the vehicle M is moving toward the left lane. When “ϕ<0” is satisfied, it means that the vehicle M moves toward the right lane. When “ϕ=0” is satisfied, the speed is zero and the time TLC is considered as a “predetermined value (for example, 1000).”

$$ψ = {sin}^{- 1} \frac{{υ}_{y}}{υ} \qquad ( 1 )$$

$${t}_{LC} = \{ \begin{matrix}\frac{{y}_{l} - {l}_{f} sin ψ - \frac{D}{2} cos ψ}{υ sin ψ} , & if ψ > 0. \\ \frac{{y}_{r} - {l}_{f} sin ψ - \frac{D}{2} cos ψ}{υ sin ψ} , & if ψ < 0.\end{matrix} \qquad ( 2 )$$

Distance Processor

The distance processor 40B calculates a distance DLC from the vehicle to the lane marking. The distance DLC is a value obtained by subtracting a length of half the width of the vehicle M from the distance from the center of the traveling lane to the lane marking. The distance processor 40B outputs a red-label flag when the distance DLC is equal to or greater than a threshold value and outputs a green-label flag when the distance DLC is less than the threshold value.

Offset Processor

The offset processor 40C calculates an offset index EPS. The offset index EPS is an index that becomes larger as the vehicle M becomes farther from the center of the traveling lane. The offset index EPS is an index corresponding to a distance from one side of the vehicle M to the lane marking. The offset processor 40C compares the offset index EPS with a threshold value and outputs a red-label flag, an orange-label flag (for example, a third index), or a green-label flag on the basis of the result of comparison.

The offset processor 40C performs processing using an offset index EPS_L and an offset index EPS_R as shown in FIG. 6. The offset index EPS_L denotes a distance from an end on the left side of the vehicle M (for example, the center in the length direction of the vehicle M or the position at which the driving support device 20 is installed) to the left lane marking, and the offset index EPS_R denotes a distance from an end on the right side of the vehicle M to the right lane marking. The offset processor performs processing using a first threshold value and a second threshold value when the offset index EPS_L is greater than the distance y1 or when the offset index EPS_R is greater than the distance yr. The distance y1 is a distance from the center of the traveling lane to the left lane marking, and the distance yr is a distance from the center of the traveling lane to the right lane marking. The first threshold value is, for example, a value obtained by adding a predetermined value to the vehicle width D. The second threshold value is, for example, a value obtained by adding a predetermined value greater than the predetermined value to the vehicle width D. For example, the first threshold value is greater than the distance y1 and the distance yr, and the second threshold value is greater than the first threshold value.

For example, it is assumed that the vehicle M is closer to the right lane marking and the offset index EPS_L is greater than the distance y1. In this case, the offset processor 40C outputs a red-label flag when the offset index EPS_L is equal to or greater than the second threshold value, outputs an orange-label flag when the offset index EPS_L is less than the second threshold value and equal to or greater than the first threshold value, and outputs a green-label flag when the offset index EPS_L is less than the first threshold value.

When the offset index EPS_L is equal to or less than the distance y1, the first threshold value and the second threshold value are not used, and a preset threshold value separate therefrom and the offset index EPS_L are compared.

SMA Processor

The SMA processor 40D calculates a noise area by statistically processing past traveling positions of the vehicle M. The noise area is an area indicating a range in which the vehicle M travels with a deviation from the center line of the traveling lane of the vehicle M when the vehicle M is traveling and depending on driving of a driver. The SMA processor 40D outputs a green-label flag when the vehicle M is traveling in the noise area and outputs a red-label flag when the vehicle M is traveling outside of the noise area.

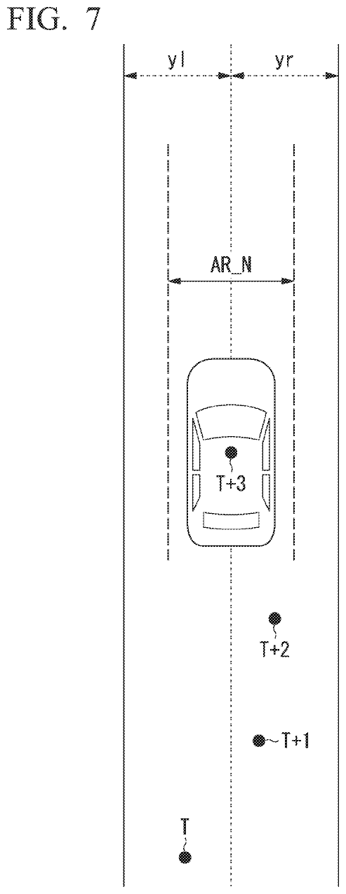

A noise area AR_N is calculated on the basis of positions at a plurality of past sampling timings as shown in FIG. 7. The noise area is calculated on the basis of a value based on an average value, a median value, or a standard deviation of deviations from the center line. For example, a range of a predetermined value σ from the center line of the traveling lane may be set as the noise area.

Integrated Processor

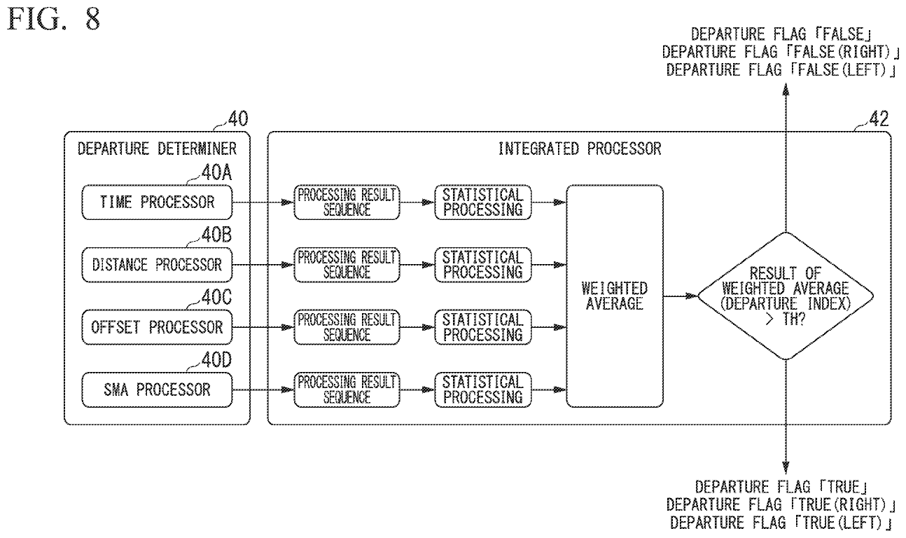

FIG. 8 is a diagram showing processes of the integrated processor 42. The integrated processor 42 acquires processing result sequences from the time processor the distance processor 40B, the offset processor 40C, and the SMA processor 40D. A processing result sequence is a processing result in a predetermined processing cycle (one or more processing cycles). The integrated processor 42 performs statistical processing on each processing result sequence and derives an index for each statistical processing result. The statistical processing includes calculation of an average value or calculation of a median value.

The integrated processor 42 performs a weighted averaging process using an index. The integrated processor 42 derives a departure index by multiplying each index by a coefficient corresponding to the index and performing the weighted averaging process. Another statistical processing may be used instead of the weighted averaging.

Then, the integrated processor 42 determines whether the departure index is greater than a threshold value TH. When the departure index is greater than the threshold value TH, the integrated processor 42 outputs a departure flag “TRUE” and a departure flag “TRUE(RIGHT)” or a departure flag “TRUE(LEFT)” which is a flag indicating a direction in which the vehicle M departs.

When the departure index is equal to or less than the threshold value TH, the integrated processor 42 outputs a departure flag “FALSE” and a departure flag “FALSE(RIGHT)” and a departure flag “FALSE(LEFT)” which are flags indicating that the vehicle M does not depart to the right and the left.

As described above, the departure determiner 40 can accurately determine whether the vehicle M is about to depart from a lane marking.

Processing details (Pattern 1) of intention determiner

(First) Flowchart

The intention determiner 50 determines whether a driver's face or sightline is directed to a predetermined object. When the face or sightline is directed to the predetermined object, it is predicted that the driver gazes the predetermined object. The predetermined object is a side rear-view mirror, a window of a driver's seat, or a window of a passenger's seat. The predetermined object may be an object which is in a sightline direction when the driver gazes the lateral direction or a neighboring lane direction.

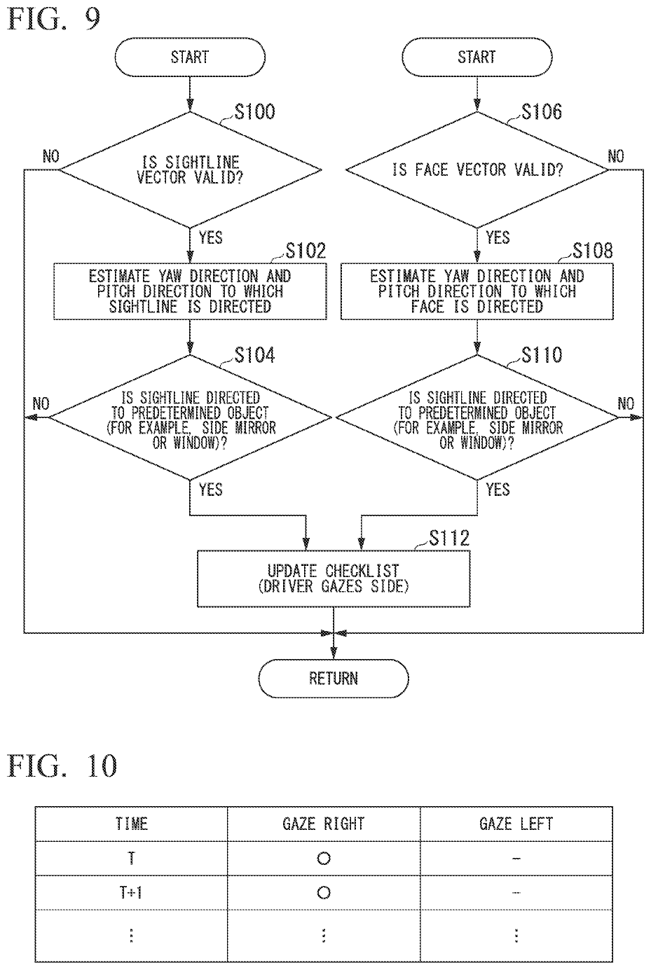

FIG. 9 is a flowchart showing an example of a flow of processes that are performed by the intention determiner 50. The processes of Steps S100 to S104 and the processes of Steps S106 to S110 in FIG. 9 may be performed in parallel, or one may be first performed and then the other may be performed.

First, the intention determiner 50 acquires a sightline vector included in sightline information and determines whether the sightline vector is valid (Step S100). The sightline vector is, for example, a vector which is defined in a two-dimensional coordinate system (for example, a coordinate system defined by a pitch direction and a yaw direction) or a three-dimensional coordinate system. For example, the intention determiner 50 determines whether the sightline vector is valid by determining whether the sightline vector satisfies a predetermined criterion (for example, a criterion based on a previous sightline vector).

Then, the intention determiner 50 estimates a direction of the driver's sightline on the basis of the pitch direction and the yaw direction of the sightline vector (Step S102). Then, the intention determiner 50 determines whether the driver's sightline is directed to a predetermined object (Step S104). When the determination result of Step S100 or Step S104 is negative, this routine of the flowchart ends. When the determination results of Step S100 and Step S104 are positive, this routine proceeds to Step S112.

Then, the intention determiner 50 acquires a face vector included in the sightline information and determines whether the face vector is valid (Step S106). The face vector is, for example, a vector which is defined in a two-dimensional coordinate system (for example, a coordinate system defined by a pitch direction and a yaw direction) or a three-dimensional coordinate system. For example, the intention determiner 50 determines whether the face vector is valid by determining whether the face vector satisfies a predetermined criterion (for example, a criterion based on a previous face vector).

Then, the intention determiner 50 estimates the direction of the driver's face on the basis of the pitch direction and the yaw direction of the face vector (Step S108). Then, the intention determiner 50 determines whether the driver's face is directed to a predetermined object (Step S110). When the determination result of Step S106 or Step S110 is negative, this routine of the flowchart ends. When the determination results of Step S106 and Step S110 are positive, this routine proceeds to Step S112.

When at least one of the driver's sightline and face is directed to the predetermined object, the intention determiner 50 updates a checklist (Step S112). Accordingly, this routine of the flowchart ends. In this routine, the checklist may be updated using only one of the sightline direction and the face direction, or the checklist may be updated when the sightline direction and the face direction match (it may be determined that a direction is gazed when both directions are the same direction).

FIG. 10 is a diagram showing an example of a checklist. The intention determiner 50 generates information in which a time and a gazing direction of the driver are correlated. For example, information indicating that the driver gazes the right when the driver's sightline or face is directed to a right object is correlated with time. For example, information indicating that the driver gazes the left when the driver's sightline or face is directed to a left object is correlated with time.

(Second) Flowchart

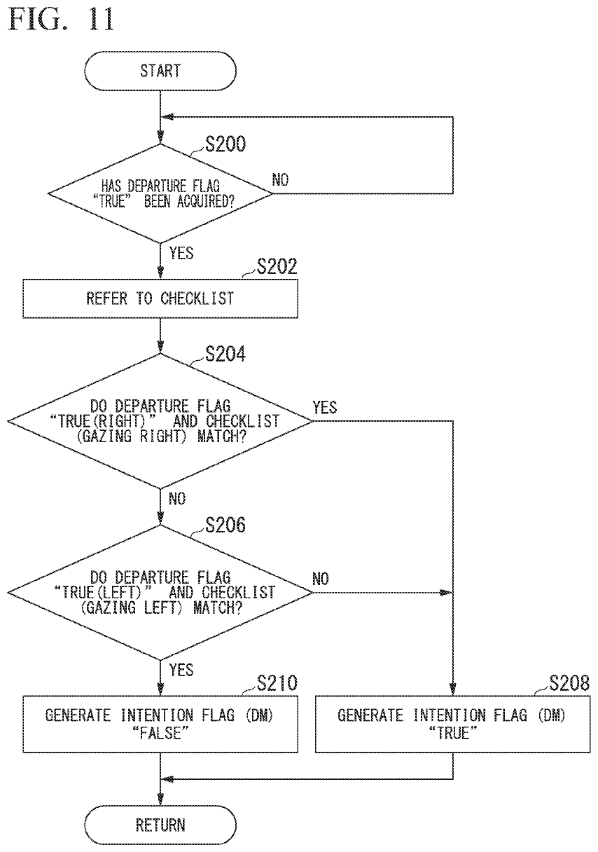

FIG. 11 is a flowchart showing an example of a flow of processes that are performed by the intention determiner 50. First, the intention determiner 50 determines whether the departure flag “TRUE” has been acquired (Step S200). The departure flag “TRUE” is output when the departure determiner 40 determines that the vehicle M departs from the lane (when the vehicle M is going to depart or the likelihood of departure is equal to or greater than a threshold value). The departure flag “TRUE(RIGHT)” is output when it is determined that the vehicle M departs to the right of the traveling lane, and the departure flag “TRUE(LEFT)” is output when it is determined that the vehicle M departs to the left of the traveling lane

Then, the intention determiner 50 refers to the checklist (Step S202). Then, when the departure flag “TRUE(RIGHT)” has been acquired, the intention determiner 50 determines whether the sightline direction in the checklist is rightward and generates an intention flag (DM) “TRUE(RIGHT)” when the sightline direction is rightward direction (Step S204 and S208).

When the departure flag “TRUE(LEFT)” has been acquired, the intention determiner 50 determines whether the sightline direction in the checklist is leftward and generates an intention flag (DM) “TRUE(LEFT)” when the sightline direction is leftward (Step S206 and S210).

When the determination results of Steps S204 and S206 are negative, the intention determiner 50 generates an intention flag (DM) “FALSE” (Step S210). As described above, when the departure direction indicated by the departure flag and the gazing direction of the driver match, the intention flag (DM) “TRUE” is generated.

Processing Details (Pattern 2) of Intention Determiner

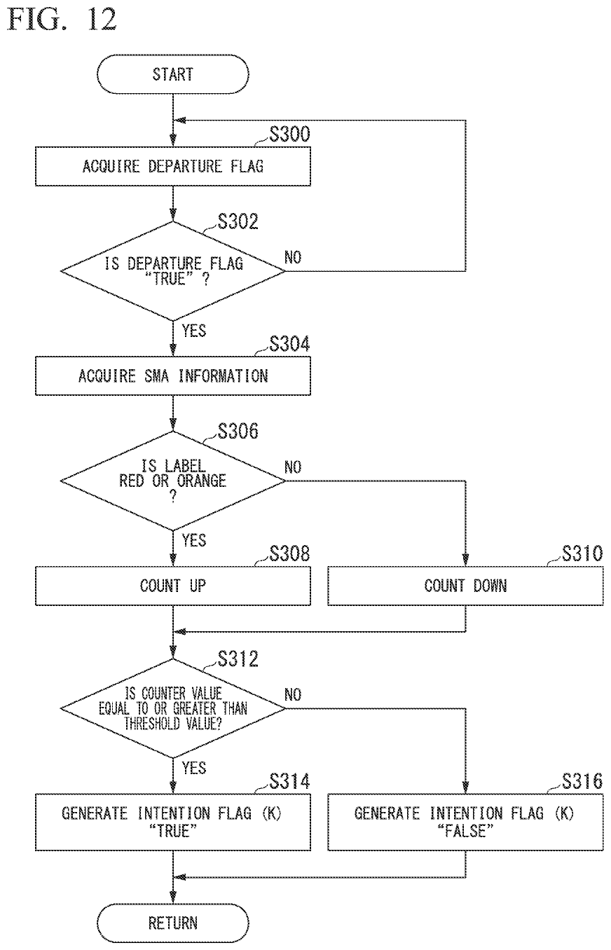

The intention determiner 50 may generate the intention flag “TRUE” or “FALSE” on the basis of the processing result from the SMA processor 40D. FIG. 12 is a flowchart showing another example of a flow of processes that are performed by the intention determiner 50.

First, the intention determiner 50 acquires a departure flag and determines whether the acquired departure flag is “TRUE” (Step S300). Then, the intention determiner 50 acquires SMA information (Step S302). The SMA information is information indicating zigzag traveling of the vehicle M output from the SMA processor and is information indicating a simple moving average value of deviations from the center line of a lane in a predetermined period. A label of red, orange, green, or the like is applied to the SMA information depending on the degree of zigzag. When the SMA processor 40D is configured to output a red label or a green label and not to output an orange label, the orange label may be omitted.

The intention determiner 50 determines whether the label of the SMA information is red or orange (Step S304). In other words, the intention determiner 50 determines whether the simple moving average value is equal to or greater than a threshold value.

When the label of the SMA information is red or orange, the intention determiner 50 counts up a counter (increases the counter by 1) (Step S308). When the label of the SMA information is not red or orange, the intention determiner 50 counts down the counter (decreases the counter by 1) (Step S310).

The intention determiner 50 determines whether the value of the counter is equal to or greater than a threshold value (Step S312). The intention determiner 50 generates an intention (K) flag “TRUE” when the value of the counter is equal to or greater than the threshold value (Step S314) and generates an intention (K) flag “FALSE” when the value of the counter is less than the threshold value (Step S316).

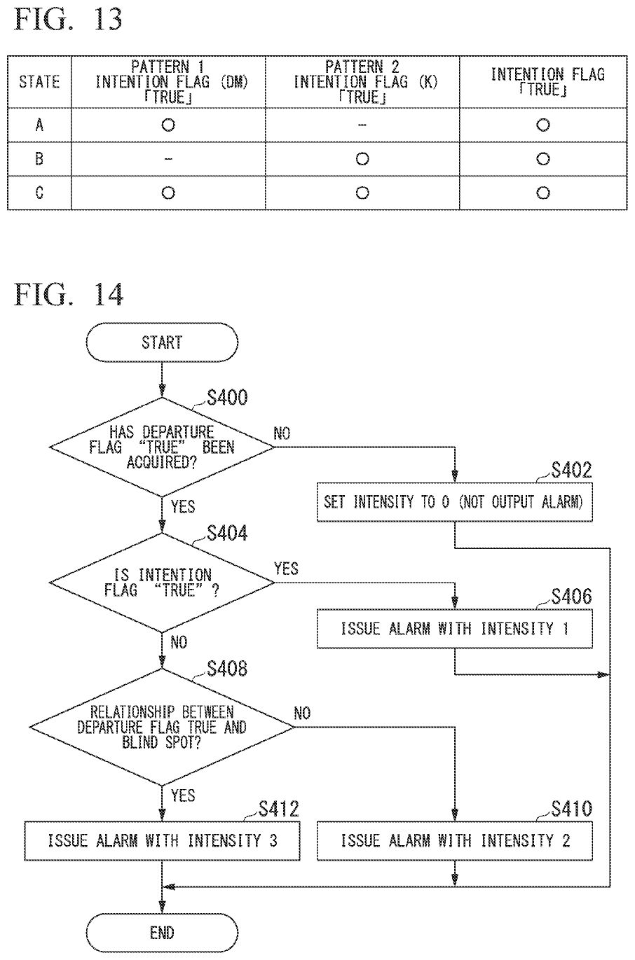

When the alarm controller 60 which will be described later is in one of States A, B, and C as shown in FIG. 13, the intention flag may be considered to be “TRUE.” State A indicates that the intention flag (DM) is “TRUE.” State B indicates that the intention flag (K) is “TRUE.” State C indicates that the intention flag (DM) and the intention flag (K) are “TRUE.”

Process Details of Alarm Controller

When the vehicle M is predicted to depart from a traveling lane on the basis of information acquired from one or more images (for example, a front-view image and a rear-view image), the alarm controller 60 determines a notification intensity of a notification for a driver of the vehicle M on the basis of a change of a target in the one or more images and causes the terminal device T to notify a notification of the determined notification intensity. The target is, for example, a lane marking of the traveling lane of the vehicle M or a driver of the vehicle M. The change of the target is a change of the position of the vehicle M relative to the lane marking and a change in behavior of the driver. For example, the alarm controller 60 determines the notification intensity on the basis of an extent by which the vehicle M becomes closer to the lane marking and the behavior indicating that the driver intends to be closer to the lane marking (a direction of a sightline or a face or an operation mode of the steering wheel). For example, the alarm controller 60 increases the notification intensity as the vehicle M becomes closer to the lane marking and deceases the notification intensity when the driver has an intention to be closer to the lane marking.

The alarm controller 60 may determine the notification intensity on the basis of the departure index. For example, the alarm controller 60 outputs a notification of a higher intensity as the departure index becomes larger (as the likelihood of departure increases). The alarm controller 60 may determine the notification intensity on the basis of one or more indices (a departure determination index) of an index based on the processing result from the time processor 40A, an index based on the processing result from the distance processor 40B, an index based on the processing result from the offset processor 40C, and an index based on the processing result from the SMA processor 40D or an index obtained by statistically processing the indices instead of the departure index.

The alarm controller 60 may determine the notification intensity with reference to the determination result from the intention determiner 50 in addition to (or instead of) the departure determination index). The alarm controller 60 causes the terminal device T to output a notification of a higher notification intensity when a direction of the driver's face or (or/and) sightline based on a rear-view image is outside of a preset range (for example, when the direction is not directed to a predetermined object) than when the direction of the driver's face or sightline is not outside of the present range (for example, when the direction is directed to the predetermined object.

More specifically, when it is determined (a1) that the direction of the driver's face or (or/and) sightline based on the rear-view image is fixed to the traveling direction and is not the leftward direction of the vehicle M for a predetermined time or more and (a2) that the vehicle M is swinging in the leftward direction (there is a high likelihood of departure) on the basis of the front-view image or the rear-view image, the alarm controller 60 causes the terminal device T to output a notification of an alarm with a predetermined intensity (a notification of intensity 2 or 3 which will be described later). When one or both of (a1) and (a2) are not satisfied, the alarm controller 60 causes the terminal device T to output a notification of an alarm with a lower intensity than the predetermined intensity or causes the terminal device T not to output a notification of an alarm.

When it is determined (b1) that the direction of the driver's face or (or/and) sightline based on the rear-view image is fixed to the traveling direction and is not the rightward direction of the vehicle M for a predetermined time or more and (b2) that the vehicle M is swinging in the rightward direction on the basis of the front-view image or the rear-view image, the alarm controller 60 causes the terminal device T to output a notification of an alarm with a predetermined intensity (a notification of intensity 2 or 3 which will be described later). When one or both of (b1) and (b2) are not satisfied, the alarm controller 60 causes the terminal device T to output a notification of an alarm with a lower intensity than the predetermined intensity or causes the terminal device T not to output a notification of an alarm.

A vehicle behind the vehicle M is present in a neighboring lane of the traveling lane may be considered. The alarm controller 60 may cause the terminal device T to output a notification of an alarm with a higher intensity (a notification with intensity 3 which will be described later) than the predetermined intensity when it is determined that another vehicle is present in a blind spot on the basis of the front-view image or the rear-view image in which the blind spot (a rear nearby area behind the vehicle M in a neighboring lane of the traveling lane) appears than when it is determined that another vehicle is not present in the blind spot.

The notification intensity may be determined as in the flowchart described below. FIG. 14 is one routine of a flowchart showing an example of a flow of processes that are performed by the alarm controller 60.

First, the alarm controller 60 determines whether the departure flag is “TRUE” (Step S400). When the departure flag is not “TRUE,” the alarm controller 60 causes the terminal device T not to output an alarm (Step S402). The intensity of the alarm at this time is “zero (0).” When the departure flag is “TRUE,” the alarm controller 60 determines whether the intention flag is “TRUE” (Step S404). When the intention flag is “TRUE,” the alarm controller 60 causes the terminal device T to output an alarm with an intensity of “1” (Step S406). The process of Step S406 is performed when the departing direction and the gazing direction of the driver match, and the routine proceeds to Step S408 when they do not match.

When the intention flag is not “TRUE,” the alarm controller 60 determines whether a relationship between the departure flag and another vehicle in the blind spot satisfies a predetermined condition (Step S408). When the predetermined condition is not satisfied, the alarm controller 60 causes the terminal device T to output an alarm with an intensity of “2” (Step S410). When the predetermined condition is satisfied, the alarm controller 60 causes the terminal device T to output an alarm with an intensity of “3” (Step S412). The intensity decreases in the order of “3,” “2,” and “1.”

The predetermined condition is a condition that the type of the departure flag and the position of another vehicle (or an object) in the blind spot match. For example, the predetermined condition is a condition that the departure flag is “TRUE(RIGHT)” and another vehicle is present in the right blind spot. For example, the predetermined condition is a condition that the departure flag is “TRUE(LEFT)” and another vehicle is present in the left blind spot. The determination of Step S408 may be performed without considering the matching. In this case, when another vehicle is present in one of the right and left blind spots, the condition associated with the blind spot is satisfied.

As described above, when (a1, b1) the driver has no intention to depart from the traveling lane, (a2, b2) the vehicle M is likely to depart from the traveling lane, and (a3, b3) another vehicle is present in the blind spot in the departing direction), the alarm controller 60 outputs a notification of an alarm with intensity 3. When (a1, b1) the driver has no intention to depart from the traveling lane, (a2, b2) the vehicle M is likely to depart from the traveling lane, and (a3, b3) another vehicle is not present in the blind spot in the departing direction), the alarm controller 60 outputs a notification of an alarm with intensity 2.

The alarm with an intensity of “1” which is output in a situation of intended departure is, for example, an alarm for causing the HMI to output an image (or an image or sound) indicating that lane change is being performed. The alarm with an intensity of “2” which is output in a situation of non-intended departure is, for example, an image in which an icon in the image is flickering and an alarm sound of a low frequency (for example, an alarm sound like sound generated when a vehicle is assumed to travel on an uneven road). The alarm with an intensity of “3” which is output in a situation of non-intended departure in which an object is present in the blind spot is, for example, an image in which an icon in the image is flickering and a sound indicating a high risk (for example, an alarm sound with high amplitude and a high frequency).

In the aforementioned example, the intention flag is generated on the basis of (A) a sightline direction or (B) a face direction, but (C) behavior of the driver's arm or hand may be considered instead thereof (or in addition thereto). In this case, the rear-view camera 12 captures an image in which the driver's arm or (and) hand appear. For example, when a change of the arm or hand in a predetermined period indicates predetermined behavior, the intention determiner 50 may determine that there is an intention of departure. The predetermined behavior is behavior with which the driver operates the steering wheel such that vehicle M moves in the departing direction of the vehicle M. For example, in the process of Step S404 in FIG. 14, an intention flag which is generated based on the predetermined behavior which is the change of the arm or hand in the predetermined period may be applied to determination. For example, the intention determiner 50 may output an alarm with intensity 1 when all of (A), (B), and (C) indicate an intention of departure or may output an alarm with intensity 1 when some thereof indicate an intention of departure. The intention determiner 50 may perform the process of Step S408 in FIG. 14 when none of (A), (B), and (C) indicates an intention of departure or when some thereof does not indicate an intention of departure. The alarm controller 60 may determine the intensity of an alarm according to the number or a combination of elements indicating an intention of departure out (A), (B), and (C).

In the aforementioned example, the driving support device 20 is applied to the driving monitoring device 1, but some or all of the functional units of the driving support device 20 may be mounted in a vehicle. The functions of the driving support device 20 may be realized by executing an application program installed in the terminal device T. In this case, for example, the terminal device T is detachably installed in the vehicle M and is used. For example, a holder for the terminal device T including a detachable member for one or both of the terminal device T and the vehicle M may be provided, and the terminal device T may be held by the holder.

When information acquired by the vehicle M can be used, the driving support device 20 can estimate a departure index of the vehicle M or a driver's intention of departure with reference to the information. The information acquired by the vehicle M is, for example, information indicating a state of a direction indicator, a steering mode (a steering torque), vehicle sensor values (a speed, acceleration, and a yaw rate), and the like. Since the driving support device 20 is not connected to the onboard network, the driving support device 20 may not refer to the information acquired by the vehicle M or may have difficulty in cooperating with the onboard network. On the other hand, in this embodiment, the driving support device 20 estimates a departure index or a driver's intention of departure using images captured by the front-view camera 10 and the rear-view camera 12 instead of using the information acquired by the vehicle M and determines the intensity of a notification. In this way, the driving support device 20 does not need to cooperate with the onboard network and can output an alarm such that a driver's driving is simply supported through post-installation. The driving support device 20 can also curb unnecessary notification by considering a driver's intention.

According to the aforementioned embodiment, since the driving support device determines a notification intensity of a notification for a driver of a vehicle M on the basis of a change of a target in an image and causes a notification device to output a notification of the determined intensity when it is predicted that the vehicle M is going to depart from the traveling lane on the basis of information acquired from an image, it is possible to output information simply and accurately.

The above-mentioned embodiment can be expressed as follows:

A control device including a storage device storing a program included in a device that is detachably attached to a vehicle via a detachable member; and

a hardware processor included in the device,

wherein the hardware processor executes the program stored in the storage device to perform:
acquiring one or more images obtained by imaging a surrounding situation of the vehicle; and
determining a notification intensity of a notification for a driver of the vehicle on the basis of a change of a target in the one or more images when it is predicted on the basis of information acquired from the one or more images that the vehicle is to depart from a traveling lane in which the vehicle is traveling and causing a notifier to output a notification of the determined notification intensity.

While the present invention has been described in conjunction with an embodiment, the present invention is not limited to the embodiment, and various modifications and replacements can be added thereto without departing from the gist of the present invention.

What is claimed is:

1. A driving support device that is detachably attached to a vehicle via a detachable member, the driving support device comprising:
a storage medium storing computer-readable instructions; and
one or more processors connected to the storage medium,
wherein the one or more processors execute the computer-readable instructions to perform:
acquiring one or more images obtained by imaging a surrounding situation of the vehicle; and
determining a notification intensity of a notification for a driver of the vehicle on the basis of a change of a target in the one or more images when it is predicted on the basis of information acquired from the one or more images that the vehicle is to depart from a traveling lane in which the vehicle is traveling and causing a notifier to output a notification of the determined notification intensity.

2. The driving support device according to claim 1, wherein the target is a road marking of a lane in which the vehicle is traveling and a driver of the vehicle, and the change of the target is a change of a position of the vehicle relative to the road marking and a change in behavior of the driver.

3. The driving support device according to claim 2, wherein the one or more images include an image in which a face of the driver driving the vehicle appears, and
wherein the one or more processors execute the computer-readable instructions to perform:
causing the notifier to output a notification of a higher notification intensity when a direction of the driver's face or sightline based on the one or more images is outside of a preset range than when the direction of the driver's face or sightline is not outside of the preset range.

4. The driving support device according to claim 2, wherein the one or more images include an image in which a face of the driver driving the vehicle appears, and
wherein the one or more processors execute the computer-readable instructions to perform:
causing the notifier to output a notification of an alarm with a predetermined intensity when it is determined (a1) that a direction of the driver's face or sightline based on the one or more images is fixed to a traveling direction and is not a leftward direction of the vehicle for a predetermined time or more and (a2) that the vehicle is swinging in the leftward direction on the basis of the one or more images and causing the notifier to output a notification of an alarm with a lower intensity than the predetermined intensity or causing the notifier not to output a notification of an alarm when one or both of (a1) and (a2) are not satisfied; and
causing the notifier to output a notification of an alarm with a predetermined intensity when it is determined (b1) that the direction of the driver's face or sightline based on the one or more images is fixed to the traveling direction and is not a rightward direction of the vehicle for a predetermined time or more and (b2) that the vehicle is swinging in the rightward direction on the basis of the one or more images and causing the notifier to output a notification of an alarm with a lower intensity than the predetermined intensity or causing the notifier not to output a notification of an alarm when one or both of (b1) and (b2) are not satisfied.

5. The driving support device according to claim 4, wherein the one or more images include an image in which a rear nearby area behind the vehicle in a neighboring lane adjacent to the traveling lane appears, and
wherein the one or more processors execute the computer-readable instructions to perform:
causing the notifier to output a notification of a third alarm with a higher intensity than the predetermined intensity when (a1) and (a2) are satisfied and it is determined (a3) that there is a vehicle in the rear nearby area on the left of the vehicle on the basis of the one or more images;
causing the notifier to output a notification of a second alarm with an intensity higher than the predetermined intensity and lower than that of the third alarm when (a1) and (a2) are satisfied and (a3) is not satisfied;
causing the notifier to output a notification of the third alarm with a higher intensity than the predetermined intensity when (b1) and (b2) are satisfied and it is determined (b3) that there is a vehicle in the rear nearby area on the right of the vehicle on the basis of the one or more images; and
causing the notifier to output a notification of the second alarm when (b1) and (b2) are satisfied and (b3) is not satisfied.

6. The driving support device according to claim 2, wherein the one or more images include an image in which one or both of an arm or a hand of the driver appear, and
wherein the one or more processors execute the computer-readable instructions to perform:
causing the notifier to output a notification of an alarm with a predetermined intensity when it is determined (c1) that the hand or the arm is not performing an operation of controlling steering of moving the vehicle to the left on the basis of the one or more images and (c2) that the vehicle is swinging in the leftward direction on the basis of the one or more images and causing the notifier to output a notification of an alarm with a lower intensity than the predetermined intensity or causing the notifier not to output a notification of an alarm when one or both of (c1) and (c2) are not satisfied, and
causing the notifier to output a notification of an alarm with a predetermined intensity when it is determined (d1) that the hand or the arm is not performing an operation of controlling steering of moving the vehicle to the right on the basis of the one or more images and (d2) that the vehicle is swinging in the rightward direction on the basis of the one or more images and causing the notifier to output a notification of an alarm with a lower intensity than the predetermined intensity or causing the notifier not to output a notification of an alarm when one or both of (d1) and (d2) are not satisfied.

7. The driving support device according to claim 6, wherein the one or more images include an image in which a rear nearby area behind the vehicle in a neighboring lane adjacent to the traveling lane appears, and
wherein the one or more processors execute the computer-readable instructions to perform:
causing the notifier to output a notification of a third alarm with a higher intensity than the predetermined intensity when (c1) and (c2) are satisfied and it is determined (c3) that there is a vehicle in the rear nearby area on the left of the vehicle on the basis of the one or more images;
causing the notifier to output a notification of a second alarm with an intensity higher than the predetermined intensity and lower than that of the third alarm when (c1) and (c2) are satisfied and (c3) is not satisfied;
causing the notifier to output a notification of the third alarm with a higher intensity than the predetermined intensity when (d1) and (d2) are satisfied and it is determined (d3) that there is a vehicle in the rear nearby area on the right of the vehicle on the basis of the one or more images; and
causing the notifier to output a notification of the second alarm when (d1) and (d2) are satisfied and (d3) is not satisfied.

8. The driving support device according to claim 4, wherein the one or more images include an image in which a rear nearby area behind the vehicle in a neighboring lane adjacent to the traveling lane appears, and
wherein the one or more processors execute the computer-readable instructions to perform:
causing the notifier to output a notification of an alarm with a higher intensity than the predetermined intensity when it is determined on the basis of the one or more images that there is a vehicle in the rear nearby area than that of when it is determined that there no vehicle in the rear nearby area.

9. A driving support unit comprising:
the driving support device according to claim 2 including a communicator configured to transmit information for causing the notifier to output the notification to the notifier;
a first camera not connected to an onboard network of the vehicle and configured to acquire an image which is included in the one or more images and includes a surrounding situation on the front of the vehicle;
a second camera not connected to the onboard network of the vehicle and configured to capture an image which is included in the one or more images and which includes the driver, a window of a driver's seat side of the vehicle, a window on a passenger's seat of the vehicle, and a rear area of the vehicle; and
a housing accommodating the driving support device, the first camera, and the second camera.

10. A storage medium storing an application program that is installed in a mobile terminal device not connected to an onboard network of a vehicle, the application program causing a computer of the mobile terminal device to perform:
a process of acquiring one or more images captured by imaging a surrounding situation of the vehicle; and
a process of determining a notification intensity of a notification for a driver of the vehicle on the basis of a change of a target in the one or more images when it is predicted on the basis of information acquired from the one or more images that the vehicle is to depart from a traveling lane in which the vehicle is traveling and causing a notifier to output a notification of the determined notification intensity.

11. A driving support method that is performed by a computer of a driving support device that is detachably attached to a vehicle via a detachable member, the driving support method comprising:
acquiring one or more images obtained by imaging a surrounding situation of the vehicle; and
determining a notification intensity of a notification for a driver of the vehicle on the basis of a change of a target in the one or more images when it is predicted on the basis of information acquired from the one or more images that the vehicle is to depart from a traveling lane in which the vehicle is traveling and causing a notifier to output a notification of the determined notification intensity.
